(19) United States
(12) Patent Application Publication
(10) Pub. No.: US 2026/0320704 A1
(43) Pub. Date: Oct. 15, 2026

(54) INFORMATION PROCESSING DEVICE

(71) Applicant: TOYOTA JIDOSHA KABUSHIKI KAISHA, Toyota-shi (JP)

(72) Inventors: Seiji MASUNAGA, Toyota-shi (JP); Tomoya TAKAHASHI, Ebina-shi (JP); Toshio MAEDA, Okazaki-shi (JP)

(21) Appl. No.: 19/386,257

(22) Filed: Nov. 12, 2025

(30) Foreign Application Priority Data
Apr. 14, 2025 (JP) 2025-066329

(51) Int. Cl. G06Q 50/06

(52) U.S. Cl. CPC G06Q 50/06

(57) ABSTRACT

A preliminary request process excludes one or more facilities for which the following day has been estimated to be a non-operating day from candidate destinations for transmission of a cooperation request for a following-day demand response that is a demand response for the following day. Based on a forecast result of power demand in the power grid for the following day, one or more facilities to which the cooperation request for the following-day demand response is to be transmitted are selected from among one or more facilities for which the following day has been estimated to be an operating day. The cooperation request for the following-day demand response is transmitted to the selected one or more facilities by the end of today.

### CROSS-REFERENCE TO RELATED APPLICATIONS

This application is based upon and claims the benefit of priority from Japanese Patent Application No. 2025-066329, filed on Apr. 14, 2025, the entire contents of which are incorporated herein by reference.

### BACKGROUND

### 1. Field

The present disclosure relates to an information processing device.

### 2. Description of Related Art

As an energy management system for facilities, systems are known that include a function of determining the daily operating status of the facility. Such a system, for example, determines whether a given day is an operating day or a non-operating day for the facility. JP2019-126193A describes an information evaluation method. This information evaluation method classifies, for each day within a predetermined past period, the operating status of the facility based on power consumption data of the facility during that period. In this way, the burden on a human operator to manually input the operating status of the facility can be reduced. The daily operating status of the facility can also be associated with the corresponding power consumption data.

Performing such an association improves the accuracy of power demand forecast can be improved. Further, based on the power demand forecast, the system can issue a cooperation request for demand response.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an information processing device includes processing circuitry. The processing circuitry is configured to execute an estimation process and a preliminary request process in order to adjust a balance between supply and demand of electric power in a power grid included in an energy management system, the power grid including multiple facilities. The estimation process includes estimating that a following day is an operating day for a facility for which today is an operating day and a duration of consecutive operating days is shorter than a specified duration, and estimating that the following day is a non-operating day for a facility for which today is a non-operating day and a facility for which a duration of consecutive operating days is longer than or equal to the specified duration. The preliminary request process includes excluding one or more facilities for which the following day has been estimated to be a non-operating day from candidate destinations for transmission of a cooperation request for a following-day demand response that is a demand response for the following day, selecting one or more facilities to which the cooperation request for the following-day demand response is to be transmitted, from among one or more facilities for which the following day has been estimated to be an operating day, based on a forecast result of power demand in the power grid for the following day, and transmitting the cooperation request for the following-day demand response to the selected one or more facilities by the end of today.

The above information processing device reduces the burden on human operators of manually entering information regarding operating days and non-operating days in advance. The information processing device also enables execution of a cooperation request on the day prior to a request target day, while reducing the likelihood of unnecessary demand forecasting and requests.

An energy management system capable of issuing such a cooperation request on the day prior to the request target day has been desired. However, although the information evaluation method described in the above-referenced publication can determine the past operating status of a facility, it cannot determine whether the following day is an operating day or a non-operating day for the facility. In a state in which it is unclear whether the following day is an operating day or a non-operating day, a cooperation request may be issued to the facility even in situations where such a request is unnecessary. Issuing cooperation requests in unnecessary situations can increase the operating costs of the system. It may also diminish user confidence in the system. On the other hand, requiring prior input of operating day and non-operating day information from the facility increases the burden on the user or system administrator. The above-described configuration addresses these problems and provides improvement.

Other features and aspects will be apparent from the following detailed description, the drawings, and the claims.

### BRIEF DESCRIPTION OF THE DRAWINGS

FIG. 1 is a schematic diagram illustrating a configuration of an energy management system according to an embodiment.

FIG. 2 is a flowchart illustrating a procedure of an estimation process executed by the information processing device shown in FIG. 1.

FIG. 3 is a flowchart illustrating a procedure of a first correction process executed by the information processing device shown in FIG. 1.

FIG. 4 is a flowchart illustrating a procedure of a second correction process executed by the information processing device shown in FIG. 1.

FIG. 5 is a flowchart illustrating a procedure of a preliminary request process executed by the information processing device shown in FIG. 1.

FIG. 6 is a flowchart illustrating a procedure of a target-day request process executed by the information processing device shown in FIG. 1.

FIG. 7 is a table illustrating an example of results of the estimation process, the correction process, and the preliminary request process of the information processing device shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Overall Configuration of Energy Management System

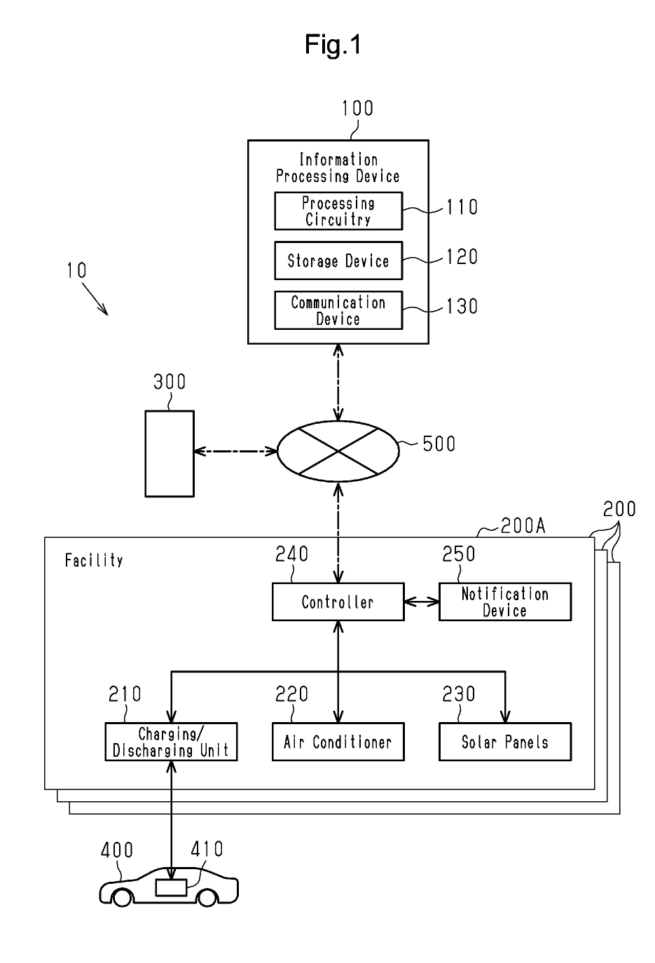

As shown in FIG. 1, an energy management system (EMS) 10 includes an information processing device 100. Further, the energy management system 10 includes multiple facilities 200. The energy management system 10 adjusts a balance between supply and demand of electric power in a power grid including multiple facilities 200.

The information processing device 100 includes processing circuitry 110, a storage device 120, and a communication device 130. The processing circuitry 110 comprises one or more processors for executing computer programs (software). The processor includes a CPU and memory, such as RAM, ROM, or the like.

The storage device 120 is configured by using a non-transitory computer-readable storage medium that can be accessed by a general-purpose or dedicated computer. The memory of the processor constituting the processing circuitry 110 is configured in the same manner. That is, in the information processing device 100, the processing circuitry 110 reads a computer program stored in the storage device 120, and the processing circuitry 110 executes various kinds of processes defined in the computer program.

The communication device 130 can transmit and receive data via the external network 500. Specifically, the information processing device 100 can receive data from each facility 200 and transmit a cooperation request to a demand response (DR) to each facility 200 by using the communication device 130. The information processing device 100, a facility controller 240 of each facility 200 to be described later, a user terminal 300 owned by an administrator of the facility 200, and the like are connected to the external network 500.

Each facility 200 includes power storage equipment, load equipment, and power generation equipment. The electric energy stored in the power storage equipment of each facility 200 and the electric power generated by the power generation equipment can be used as the power consumed by the load equipment of the facility 200. The electric power generated by the power generation equipment of each facility 200 can also be used as electric power for charging the power storage equipment of the facility 200.

In the present embodiment, the facility 200 includes a charging/discharging unit 210 as power storage equipment, an air conditioner 220 as load equipment, and solar panels 230 as power generation equipment. The charging/discharging unit 210 is connectable to the electric vehicle 400. The charging/discharging unit 210 charges a battery 410 for vehicle traveling included in the electric vehicle 400. The charging/discharging unit 210 is used as a power source for supplying electric energy stored in the battery 410 to the facility 200. The power storage equipment is not limited to the charging/discharging unit 210, and may be a storage battery or the like. The load equipment is not limited to the air conditioner 220, and may be a lighting device, a production facility (manufacturing facility), or the like. In addition, the power generation equipment is not limited to the solar panels 230, and may be a wind power generation device, a hydraulic power generation device, a thermal power generation device, or the like.

The power grid managed by the information processing device 100 includes multiple facilities 200. In this description, the power grid is a system in which the facilities 200 perform supply, distribution, and control of electric power in cooperation with each other. In the power grid, the electric energy stored in the power storage equipment of the first facility and the electric power produced by the power generation equipment of the first facility can be used as the electric power with which the power storage equipment of the second facility is charged or the electric power consumed by the load equipment of the second facility.

The demand response applied to each facility 200 in the present disclosure includes an upward DR and a downward DR. The upward DR is a measure in which, when power generation in the power grid is in surplus, the power consumption of each facility 200 is temporarily increased by operating load equipment and charging storage equipment of each facility 200. The downward DR is a measure in which, when power demand in the power grid is high, the power consumption of each facility 200 is temporarily reduced by controlling load equipment and discharging storage equipment of the facility 200. By implementing the upward DR and the downward DR, the supply-demand balance of the entire power grid is adjusted. As a result, stable power supply is maintained.

The cooperation request for the upward DR includes, for example, a request for increasing the output of the air conditioner 220 and/or a request for bringing the battery 410 into a chargeable state by connecting the electric vehicle 400 to the charging/discharging unit 210. The cooperation request for the downward DR includes, for example, a request for reducing the output of the air conditioner 220 and/or a request for bringing the battery 410 into a dischargeable state by connecting the electric vehicle 400 to the charging/discharging unit 210 in advance.

Each facility 200 includes a facility controller 240. The facility controller 240 includes processing circuitry, a storage device, and a communication device, similarly to the information processing device 100 described above. The communication device of the facility controller 240 and the communication device 130 of the information processing device 100 can communicate with each other via the external network 500.

The facility controller 240 is connected to power storage equipment, load equipment, and power generation equipment of each facility 200. The facility controller 240 manages the power storage equipment, the load equipment, and the power generation equipment of each facility 200. Specifically, the facility controller 240 transmits the operation data of the power storage equipment, the load equipment, and the power generation equipment of the facility 200 to the information processing device 100 via the external network 500. In addition, the facility controller 240 receives a control command for the power storage equipment, the power generation equipment, and the load equipment of the facility 200 from the information processing device 100 via the external network 500. The facility controller 240 transmits the received control command to the power storage equipment, the power generation equipment, and the load equipment of the facility 200.

Each facility 200 has operating days and non-operating days. An operating day refers to a day on which production activities and/or service provision are carried out at the facility 200. A non-operating day refers to a day on which neither production activities nor service provision are carried out at the facility 200. On an operating day of the facility 200, the power consumption of the facility 200 is relatively high. On a non-operating day of the facility 200, the power consumption of the facility 200 is relatively low.

Each facility 200 includes a notification device 250. The notification device 250 is capable of notifying an administrator of the facility 200 of a cooperation request for a demand response to the facility 200 transmitted from the information processing device 100. The notification device 250 is, for example, a display device such as a monitor already connected to the facility controller 240. The notification device 250 is not limited to the above, and may be the user terminal 300 or the like owned by the administrator of the facility 200. The user terminal 300 is connected to the information processing device 100 via an external network 500.

### Estimation Process Executed by the Processing Circuitry 110

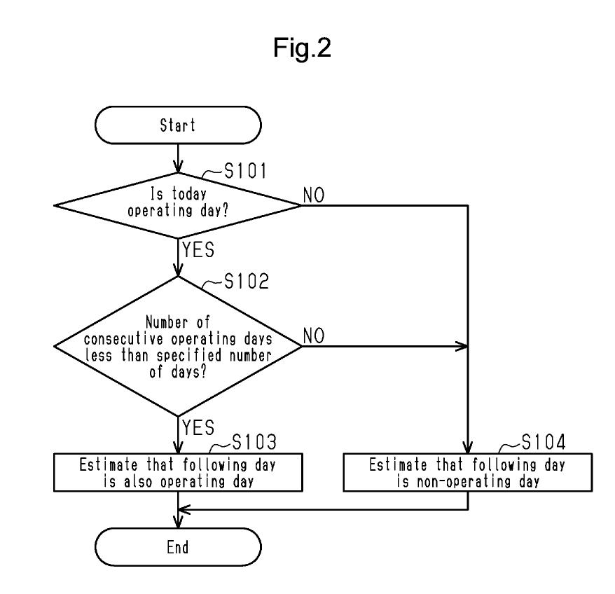

Next, an estimation process executed by the processing circuitry 110 of the information processing device 100 will be described. FIG. 2 is a flowchart illustrating a processing procedure of an estimation process executed by the processing circuitry 110 of the information processing device 100. The processing circuitry 110 executes estimation process for each facility 200. The processing circuitry 110 executes the estimation process for each facility 200 at a prescribed time once a day. For example, the processing circuitry 110 executes the estimation process for each facility 200 at 4 p.m. In the following description, an estimation process performed by the processing circuitry 110 for a facility 200A that is one of the multiple facilities 200 illustrated in FIG. 1 will be described.

In the following description, the day on which the processing circuitry 110 executes the process is referred to as ‘today.’ The day prior to the day on which the processing circuitry 110 executes the process is referred to as a ‘previous day,’ and the day after the processing is referred to as a ‘following day.’ A day that is subject of each process executed by the processing circuitry 110 is referred to as a ‘target day.’

In step S101, the processing circuitry 110 refers to the result already estimated through the estimation process, and determines whether today is an operating day for the facility 200A. When today is an operating day (S101: YES), the processing circuitry 110 advances the processing to step S102. When today is not an operating day (S101: NO), the processing circuitry 110 advances the process to step S104.

In step S102, the processing circuitry 110 determines whether the number of consecutive operating days for the facility 200A is less than a specified number of days. The specified number of days is, for example, five. The number of consecutive operating days is calculated including today. For example, when the previous day is a non-operating day and today is an operating day, the number of consecutive operating days is one. When the number of consecutive operating days is less than the specified number of days (S102: YES), the processing circuitry 110 advances the process to step S103. When the number of consecutive operating days is greater than or equal to the specified number of days (S102: NO), the processing circuitry 110 advances the process to step S104.

In step S103, the processing circuitry 110 estimates that the following day is also an operating day for the facility 200A. That is, the processing circuitry 110 estimates that the following day is an operating day for the facilities 200 for which today is an operating day (S101: YES) and the duration of consecutive operating days is shorter than a specified duration (S102: YES).

In step S104, the processing circuitry 110 estimates that the following day is a non-operating day for the facility 200A. That is, the processing circuitry 110 estimates that the following day is a non-operating day for a facility 200 for which today is a non-operating day (S101: NO) or the duration of consecutive operating days is longer than or equal to the specified duration (S102: NO).

### Correction Process Executed by the Processing Circuitry 110

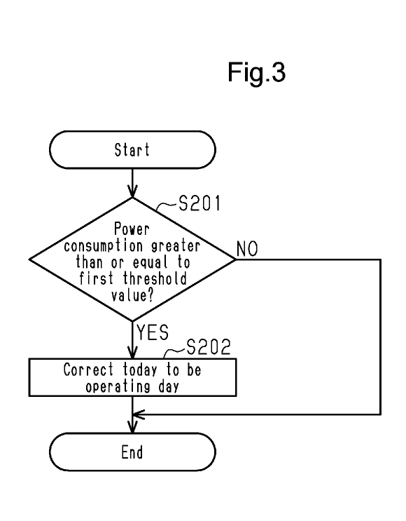

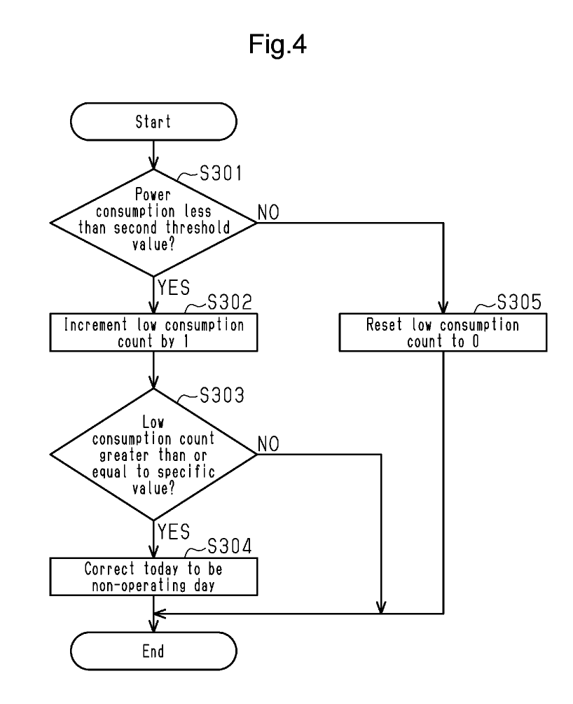

Next, a correction process executed by the processing circuitry 110 of the information processing device 100 will be described. The correction process is a process of correcting the estimation result of the estimation process performed on the previous day, based on the power consumption of today. FIG. 3 is a flowchart illustrating a procedure of a first correction process executed by the processing circuitry 110 of the information processing device 100. FIG. 4 is a flowchart illustrating a procedure of a second correction process executed by the processing circuitry 110 of the information processing device 100. The processing circuitry 110 executes the first correction process illustrated in FIG. 3 on the target day estimated as a non-operating day by the estimation process described above. In addition, the processing circuitry 110 executes the second correction process illustrated in FIG. 4 on the target day estimated to be an operating day by the estimation process executed on the previous day. In the following description, similarly to the estimation process, the correction process performed by the processing circuitry 110 on the facility 200A among the multiple facilities 200 illustrated in FIG. 1 will be described.

First, the first correction process will be described. As shown in FIG. 3, in step S201, the processing circuitry 110 determines whether the power consumption in the facility 200A is greater than or equal to a first threshold value. When the power consumption is greater than or equal to the first threshold value (S201: YES), the processing circuitry 110 advances the process to S202. In step S202, the processing circuitry 110 corrects today to an operating day for the facility 200A. That is, when having estimated that today is a non-operating day for the facility 200, the processing circuitry 110 corrects today to be an operating day for the facility 200 if the power consumption of the facility 200 on today is greater than or equal to the first threshold value (S201: YES). Upon completion of step S202, the processing circuitry 110 ends the first correction process.

When the power consumption in the facility 200A is less than the first threshold value (S201: NO), the processing circuitry 110 ends the first correction process. In a case in which step S202 is not executed, the processing circuitry 110 repeats the first correction process for each prescribed time T1. The prescribed time T1 is, for example, one minute. The power consumption used for the determination in step S201 may be the maximum value of the power consumption during the prescribed time T1 from the end of the previous first correction process to the start of the current first correction process. The prescribed time T1 and the power consumption used for the determination of the step S201 can be appropriately changed. For example, the prescribed time T1 may be one second or one hour. Further, the power consumption used for the determination in step S201 may be a mean value of the power consumption in the prescribed time T1.

Next, the second correction process will be described. As shown in FIG. 4, in step S301, the processing circuitry 110 determines whether the power consumption in the facility 200A is less than or equal to a second threshold value. When the power consumption is less than or equal to the second threshold value (S301: YES), the processing circuitry 110 advances the process to step S302. When the power consumption is larger than the second threshold value (S301: NO), the processing circuitry 110 advances the process to step S305.

In step S302, the processing circuitry 110 increments the low consumption count by 1. Thereafter, the processing circuitry 110 advances the process to step S303. The low consumption count is a variable handled by the processing circuitry 110. The processing circuitry 110 resets the low consumption count to 0 at the preset end time of each day.

In step S303, the processing circuitry 110 determines whether the low-consumption count is greater than or equal to a specified value P. When the low consumption count is greater than or equal to the specified value P (S303: YES), the processing circuitry 110 advances the process to S304. In step S304, the processing circuitry 110 corrects today to a non-operating day for the facility 200A. When the low-consumption count is less than the specified value P (S303: NO), the processing circuitry 110 ends the second correction process.

In step S305, the processing circuitry 110 resets the low consumption count to 0. Thereafter, the processing circuitry 110 ends the second correction process.

In a case in which step S304 is not executed, the processing circuitry 110 repeats the second correction process every prescribed time T2. The prescribed time T2 is, for example, one hour. At this time, the power consumption used for the determination in step S301 may be the maximum value of the power consumption during the prescribed time T2 from the end of the previous second correction process to the start of the current second correction process. At this time, the low consumption count is incremented by 1 each time a state in which the maximum value of the power consumption in the facility 200A is less than or equal to the second threshold value is maintained for one hour. In a case in which the specified value P of the low consumption count used in step S303 is five, when a state where the maximum value of the power consumption in the facility 200A is less than or equal to the second threshold value is maintained for five hours, the processing circuitry 110 corrects today to a non-operating day for the facility 200A. That is, when having estimated that today is an operating day for the facility 200, the processing circuitry 110 corrects today to be a non-operating day for the facility 200 if the duration in which the power consumption of the facility 200 on today is less than or equal to the second threshold value is longer than or equal to a specified time.

The prescribed time T2 and the power consumption used for the determination of the step S301 can be appropriately changed. For example, the prescribed time T2 may be one second or three hours. Further, the power consumption used for the determination in step S301 may be a mean value of the power consumption in the prescribed time T2.

In the present embodiment, at the operation start time on an operating day for the facility 200, the processing circuitry 110 initiates the second correction process. The timing of starting the second correction process is not limited to the above. For example, the processing circuitry 110 may initiate the second correction process several hours before the operation start time on an operating day for the facility 200. Further, the processing circuitry 110 may start the second correction process at a timing when the date is changed.

After today is corrected to an operating date in step S202 of the first correction process, the processing circuitry 110 may start the second correction process. The processing circuitry 110 may start the first correction process after today is corrected to a non-operating day in step S304 of the second correction process.

### Preliminary Request Process Executed by the Processing Circuitry 110

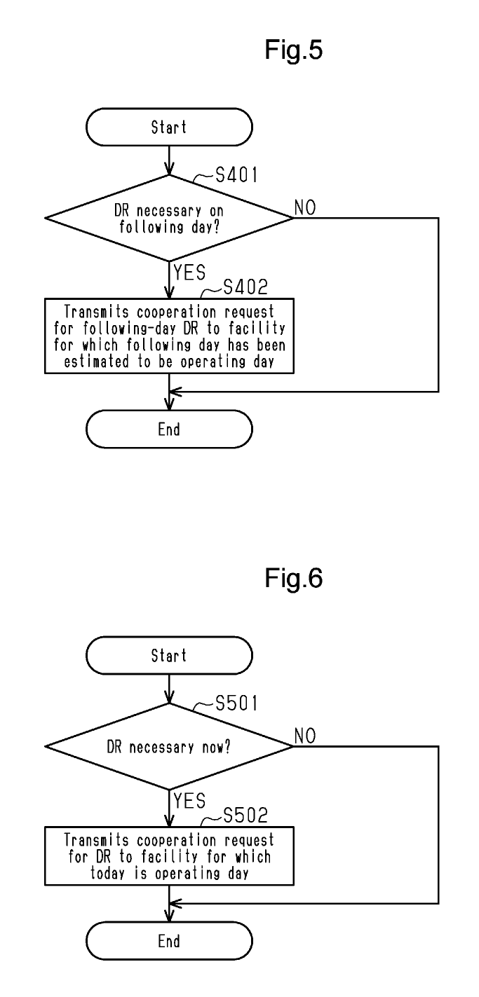

Next, the preliminary request process executed by the processing circuitry 110 of the information processing device 100 will be described. FIG. 5 is a flowchart illustrating a procedure of a preliminary request process executed by the processing circuitry 110 of the information processing device 100. As will be described later, the processing circuitry 110 executes the preliminary request process at a prescribed time after executing the estimation process once a day.

As shown in FIG. 5, in step S401, the processing circuitry 110 of the information processing device 100 estimates whether a demand response is necessary for the following day. That is, in step S401, the necessity of the following-day demand response as the demand response scheduled to be performed on the following day is estimated. The information processing device 100 estimates today whether the following-day demand response is necessary based on the forecast result of the power demand of the following day in the power grid managed by the information processing device 100. For example, the information processing device 100 can estimate whether the following-day demand response is necessary based on the forecast of the power consumption of the following day in each of the multiple facilities 200. The information processing device 100 may additionally use the weather data of the following day, the operation schedule of the power plant of the following day, and the like to estimate whether the demand response is necessary. When it has been estimated that the following-day demand response is necessary (S401: YES), the processing circuitry 110 advances the process to step S402. When it has been estimated that the following-day demand response is unnecessary (S401: NO), the processing circuitry 110 ends the preliminary request process.

In step S402, the processing circuitry 110 transmits a cooperation request for the following-day demand response to the facility 200, which has been estimated that the following day is an operating day, within today. In detail, the information processing device 100 excludes the facility 200 for which it has been estimated that the following day is a non-operating day from the candidate destinations for transmission of a cooperation request for the following-day demand response. Thereafter, the information processing device 100 selects the facilities 200 to which the cooperation request for the following-day demand response is to be transmitted from among the facilities 200 for which it has been estimated that the following day is an operating day, based on the forecast result of the power demand in the power grid for the following day. The information processing device 100 transmits a cooperation request for the following-day demand response to the selected facility 200 by the end of today. After completion of step S402, the processing circuitry 110 ends the preliminary request process.

The processing circuitry 110 executes the preliminary request process at a prescribed time of each day. The preliminary request process may be executed by the business end time of each facility 200. In addition, the preliminary request process may be executed after a time required for the determinations by the first correction process and the second correction process to be corrected elapses.

### Target-Day Request Process Executed by the Processing Circuitry 110

Next, the target-day request process executed by the processing circuitry 110 of the information processing device 100 will be described. FIG. 6 is a flowchart illustrating a procedure of a target-day request process executed by the processing circuitry 110 of the information processing device 100.

The processing circuitry 110 determines, based on today’s power consumption in the power grid, whether to transmit a cooperation request for today’s demand response to the facility 200 for which it has been estimated that today is an operating day. That is, the today’s demand response is a demand response requested today. As shown in FIG. 6, in step S501, the processing circuitry 110 of the information processing device 100 determines whether a demand response is currently necessary based on the current power consumption in the power grid. For example, when the current power consumption exceeds a threshold value for determining that the current power consumption is too large with respect to the supply power, it is determined that the downward DR is necessary. For example, when the current power consumption falls below a threshold value for determining that the current power consumption is too small with respect to the supply power, it is determined that the upward DR is necessary. When the current demand response is necessary (S501: YES), the processing device advances the process to step S502. When the current demand response is not necessary (S501: NO), the processing device ends the target-day request process.

In step S502, the processing circuitry 110 transmits a cooperation request for a demand response to the facilities 200 for which today is an operating day. That is, in a case in which it is determined that it is necessary to perform the cooperation request for the today’s demand response (S501: YES), the processing circuitry 110 transmits the cooperation request for the today’s demand response to the facility 200 for which today has been estimated to be an operating day.

The processing circuitry 110 repeatedly executes the target-day request process for each prescribed time T3. The prescribed time T3 is, for example, 30 minutes. The processing circuitry 110 may end the repetition of the target-day request process after the completion of step S502. The processing circuitry 110 may repeatedly execute the target-day request process even after the completion of step S502. After transmitting the cooperation request in step S502 once, the processing circuitry 110 may execute the target-day request process for each prescribed time T3 longer than the prescribed time T4.

### Operation of the Present Embodiment

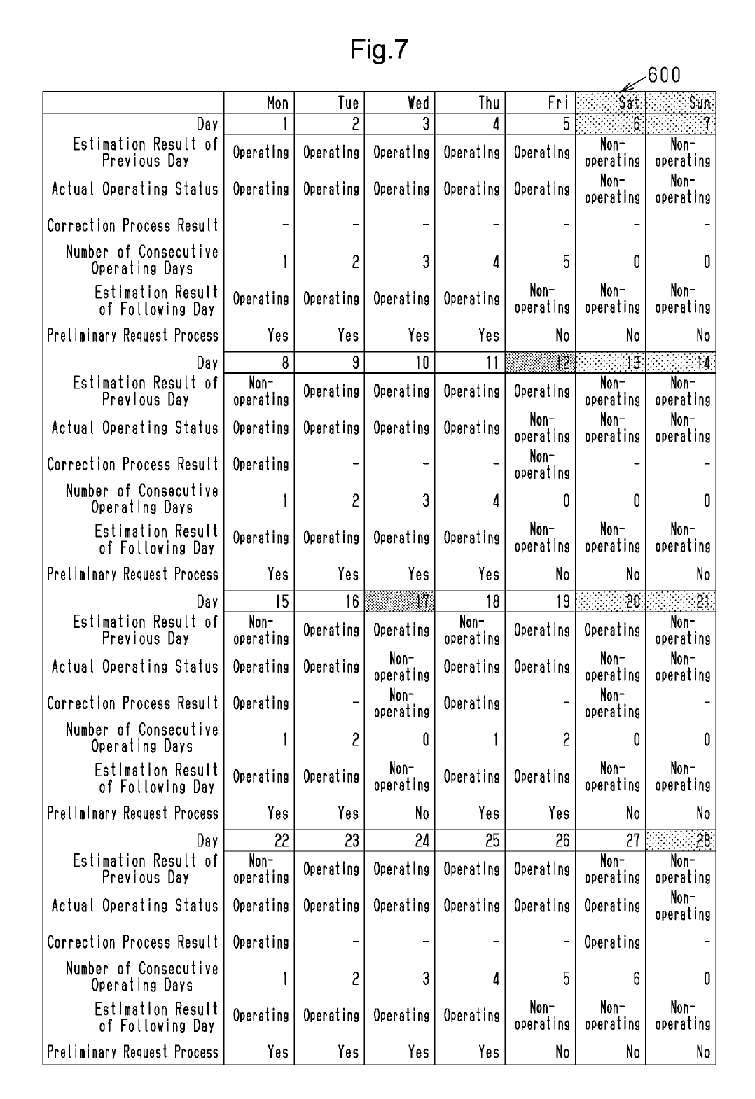

The operation of the information processing device 100 will be described with reference to FIG. 7. A table 600 of FIG. 7 illustrates the operating status of each day in the facility 200A and the results of the estimation process, the correction process, and the preliminary request process. The column ‘Estimation Result of Previous Day’ of the table 600 indicates an estimation result in the estimation process illustrated in FIG. 2 performed on the previous day. The column ‘Actual Operating Status’ indicates the actual operating status of the facility 200A on the target day. The column ‘Correction Process Result’ indicates the determination of the operating status on the target day after the first correction process and the second correction processing shown in FIGS. 3 and 4, respectively, are performed. When the estimation result of the previous day is not corrected, a dash symbol (‘-’) is entered in the column ‘Correction Process result.’ The column ‘Number of Consecutive Operating Days’ indicates the number of consecutive operating days including the target day. The column ‘Estimation Result of Following Day’ indicates the result of the estimation process shown in FIG. 2 performed on the target day. That is, the content of the column ‘Estimation Result of Previous Day’ of the target day is the same as the content of ‘Estimation Result of Following Day’ of the previous day. The column ‘Preliminary Request Process’ indicates whether the target day is a target of the preliminary request process. In a case in which the target day is a target of the preliminary request process, ‘Yes’ is entered in the column ‘Preliminary Request Process.’ In a case in which the target day is not a target of the preliminary request process, ‘No’ is entered in the column ‘Preliminary Request process.’

Day 1, the first day in table 600, is Monday. In the facility 200A, basically, Monday to Friday are operating days, and Saturday and Sunday are non-operating days. Although Day 12 and Day 17 correspond to Friday and Wednesday, respectively, they are non-operating days for the facility 200A because the facility 200A is closed on those days. Further, Day 27 is Saturday, but is an operating day because the facility 200A performs temporary business. In the following description, operating day/non-operating day for the facility 200A may be simply referred to as operating day/non-operating day.

In the facility 200A, the specified number of days in step S102 of the estimation process illustrated in FIG. 2 is set to five. In other words, the processing circuitry 110 advances the process from step S102 to step S104 when the number of consecutive operating days is five or more. Here, it is assumed that Day 1, which is the first day in the table 600, has been estimated to be an operating day.

On Day 1, the previous day has been estimated to be an operating day for the facility 200A and was actually an operating day. Therefore, the low-consumption count in the second correction process shown in FIG. 4 is maintained to be less than the specified value P. Therefore, the estimation result is not corrected. Therefore, since Day 1 is an operating day, the processing circuitry 110 sets the facility 200A as the request target of the target-day request process illustrated in FIG. 6.

On Day 1, the number of consecutive operating days for the facility 200A is one. Therefore, in step S103 of the estimation process illustrated in FIG. 2, the processing circuitry 110 estimates that Day 2, which is the following day, is an operating day. Since it has been estimated that Day 2, which is the following day, is an operating day, the processing circuitry 110 sets the facility 200A as a request target of the preliminary request process illustrated in FIG. 5 executed by the end of Day 1.

On each of Day 2 to Day 4, the processing circuitry 110 performs the same process as on Day 1. That is, on each of Day 2 through Day 4, the processing circuitry 110 does not correct the estimation result of the previous day, and estimates that the following day is an operating day. Therefore, the processing circuitry 110 sets the facility 200A as a request target of the target-day request process performed on each of Day 2 through Day 4. In addition, the processing circuitry 110 sets the facility 200A as a request target of the preliminary request process executed during Day 2 through Day 4. On Day 4, the number of consecutive operating days is four.

On Day 5, it has been estimated that Day 4, which is the previous day, was an operating day for the facility 200A. Day 5 is actually an operating day for the facility 200A. On Day 5, the number of consecutive operating days for the facility 200A is five. Therefore, in step S102 of the estimation process illustrated in FIG. 2, the processing circuitry 110 determines that the number of consecutive operating days for the facility 200A is greater than or equal to the specified number of days (S102: NO). As a result, in step S104 of the estimation process, the processing circuitry 110 estimates that Day 6, which is the following day, is a non-operating day. Therefore, the processing circuitry 110 excludes the facility 200A from the request targets of the preliminary request process executed by the end of Day 5. Specifically, the processing circuitry 110 excludes the facility 200A from candidate destinations for transmission of the cooperation request for the following-day demand response.

Since Day 6 is Saturday, the facility 200A is actually a non-operating day. Therefore, in step S201 of the first correction process shown in FIG. 3, the power consumption is maintained to be less than a first specified value. Therefore, the estimation result of Day 5 on the previous day is not corrected. Since Day 6 is a non-operating day, the processing circuitry 110 excludes the facility 200A from the request target of the target-day request process executed on Day 6. Specifically, the processing circuitry 110 excludes the facility 200A from the candidate destinations for transmission of the cooperation request for the demand response in the target-day request process shown in FIG. 6. Since Day 6 is a non-operating day, the processing circuitry 110 estimates that Day 7, which is the following day, is a non-operating day in step S104 of the estimation process illustrated in FIG. 2. Therefore, the processing circuitry 110 excludes the facility 200A from the request targets of the preliminary request process to be executed by the end of Day 6.

Day 7, which is Sunday, is actually a non-operating day for the facility 200A. Therefore, the processing circuitry 110 excludes the facility 200A from the request target of the target-day request process executed on Day 7. Further, since Day 7 is a non-operating day, the processing circuitry 110 estimates that Day 8 is a non-operating day.

Day 8 has been estimated to be a non-operating day for the facility 200A through the estimation process performed on Day 7, which is the previous day. However, Day 8 is actually an operating day for the facility 200A. The power consumption on Day 8, which is an operating day for the facility 200A, is greater than or equal to the first threshold value in the step S201 of the first correction process shown in FIG. 3. Therefore, the processing circuitry 110 corrects the operating status of the facility 200A on Day 8 from a non-operating day estimated on Day 7, which is the previous day, to an operating day. In this way, even when the estimation result is different from the actual operating status, the processing circuitry 110 can correct the determination to the correct operating status. The processing circuitry 110 estimates that Day 9, which is the following day, is an operating day because Day 8 is corrected to be an operating day. The subsequent processes on Day 8 are the same as the processes executed by the processing circuitry 110 on Day 1, and thus description thereof will be omitted.

On each of Day 9 through Day 11, the processing circuitry 110 performs the same processes as on Day 1. That is, on each of Day 9 through Day 11, the estimation result of the previous day is not corrected, and the following day is estimated to be an operating day. Therefore, the processing circuitry 110 sets the facility 200A as a request target of the preliminary request process performed on each of Day 9 through Day 11. On Day 11, the number of consecutive operating days for the facility 200A is four.

Day 12 has been estimated to be an operating day for the facility 200A through the estimation process performed on Day 11, which is the previous day. However, Day 12 is actually a non-operating day for the facility 200A. At a certain time on Day 12, the low-consumption count in the second correction process illustrated in FIG. 4 is greater than or equal to the specified value P. As a result, in step S304, the processing circuitry 110 corrects Day 12, which is today, to a non-operating day. Therefore, on Day 12, the processing circuitry 110 excludes the facility 200A from the request targets of the target-day request process performed on Day 12. Having corrected Day 12 to be a non-operating day, the processing circuitry 110 estimates that Day 13, which is the following day, is an non-operating day in step S104 of the estimation process illustrated in FIG. 2.

Day 13, which is Saturday, is actually a non-operating day for the facility 200A. Therefore, in step S201 of the first correction process shown in FIG. 3, the power consumption is maintained to be less than the first specified value. As a result, the estimation result for Day 12, which is the previous day, is not corrected. The subsequent processes performed by the processing circuitry 110 on Day 13 and Day 12 are the same as those on Day 6 and Day 7, respectively, and thus the description thereof will be omitted.

The processes performed by the processing circuitry 110 on Day 15 and Day 16 are the same as those on Day 8 and Day 9, and thus the description thereof will be omitted. Day 17 has been estimated to be an operating day for the facility 200A through the estimation process performed on Day 16, which is the previous day. However, Day 17 is actually a non-operating day for the facility 200A. Therefore, similarly to the process on Day 12, the processing circuitry 110 corrects Day 17, which is today, to a non-operating day. On Day 17, the processing circuitry 110 excludes the facility 200A from the request targets of the target-day request process illustrated in FIG. 6. Since Day 17 is a non-operating day, the processing circuitry 110 estimates that Day 18, which is the following day, is a non-operating day.

Day 18 has been estimated to be a non-operating day for the facility 200A through the estimation process performed on Day 17, which is the previous day. However, Day 18 is actually an operating day for the facility 200A. Therefore, similarly to the process on Day 8, the processing circuitry 110 corrects Day 18, which is the target day and has been estimated to be a non-operating day on Day 17 (the previous day), to be an operating day. On Day 18, the number of continuous operating day is one, and thus the processing circuitry 110 estimates that Day 19 is an operating day. Day 19 is actually an operating day. On Day 19, the number of consecutive operating days is two. Therefore, on Day 19, the processing circuitry 110 estimates that Day 20, which is the following day, is an operating day.

Day 20 has been estimated to be an operating day for the facility 200A through the estimation process performed on Day 19, which is the previous day. However, Day 20 is actually a non-operating day for the facility 200A. Therefore, similarly to the process on Day 12, the processing circuitry 110 corrects Day 20, which is today, to a non-operating day. On Day 20, the processing circuitry 110 excludes the facility 200A from the request target in the target-day request process illustrated in FIG. 6. Having corrected Day 20 to be a non-operating day, the processing circuitry 110 estimates that Day 21, which is the following day, is a non-operating day in step S104 of the estimation process illustrated in FIG. 2. Thereafter, the processes executed by the processing circuitry 110 is the same as the processes executed on Day 6, and thus the description thereof will be omitted. In addition, the processes executed by the processing circuitry 110 on Day 21 are the same as the processes executed on Day 7, and thus the description thereof will be omitted.

Since the processes executed during Day 22 through Day 26 are the same as the processes executed during Day 1 through Day 5, the description thereof will be omitted. On Day 26, the number of consecutive operating days is five. Therefore, the processing circuitry 110 estimates that Day 27 is an operating day.

Day 27 has been estimated to be a non-operating day for the facility 200A through the estimation process performed on Day 26, which is the previous day. However, Day 27 is actually an operating day for the facility 200A. Therefore, similarly to the process on Day 8, the processing circuitry 110 corrects the determination for Day 27, which is the target day, from a non-operating day estimated on Day 26, which is the previous day, to an operating day. On Day 27, the number of consecutive operating days is six, and thus the processing circuitry 110 estimates that Day 28 is a non-operating day. Therefore, the processing circuitry 110 excludes the facility 200A from the request target of the preliminary request process to be executed on Day 27. Day 28 is actually a non-operating day.

### Advantages of the Present Embodiment

(1) The information processing device 100 estimates whether the following day is an operating day or a non-operating day for the target facility 200 based on information indicating whether today is an operating day or a non-operating day for the target facility 200 and the number of consecutive operating days for the target facility 200. The information processing device 100 excludes the facilities 200 for which it has been estimated that the following day is a non-operating day from the candidate destinations for transmission of the cooperation request for the following-day demand response. In addition, the information processing device 100 selects the facilities 200 to which the cooperation request for the following-day demand response is to be transmitted, from among the facilities 200 for which it has been estimated that the following day is an operating day, based on the forecast result of the power demand in the power grid for the following day. The information processing device 100 performs the preliminary request process on the selected facilities 200. In the preliminary request process, a cooperation request for the following-day demand response is transmitted by the end of today.

According to this configuration, it is possible to make a request for power supply-demand adjustment for the following day during the target day to the facility 200 for which it has been estimated that the target day is an operating day and the following day is an operating day. As a result, the balance between the demand and supply of electric power can be effectively adjusted.

In addition, the preliminary request process is not performed for a non-operating day on which the request cannot be satisfied and the previous day in a case in which the following day is a non-operating day on which it is not necessary to perform power supply-demand adjustment. Accordingly, it is possible to suppress an increase in operation cost due to execution of unnecessary demand forecast and cooperation request while saving time and effort to input information of operating day/non-operating day in advance.

When a request for power supply-demand adjustment is issued to a facility 200 on a non-operating day, there is a risk that the user’s trust in the system may be reduced or that the user may attempt to comply with the request even though the day is a non-operating day. In this regard, in the present embodiment, a request for adjustment of power supply and demand is not made to the facilities 200 for which it has been estimated that the following day is a non-operating day. As a result, it is possible to reduce the possibility that the reliability of the user with respect to the system decreases or the user tries to respond to a request on a non-operating day.

(2) The processing circuitry 110 performs a correction process of correcting the estimation result of the estimation process performed on the previous day based on the power consumption of today. Accordingly, even when the estimation result obtained on the previous day is different from the actual operating status on the target day, it is possible to correctly correct the operating status on the target day based on the power consumption on the target day. As a result, it is possible to suppress a decrease in the accuracy of the demand forecast.

(3) In a case in which it has been estimated that today is a non-operating day for the facility 200, the processing circuitry 110 corrects today to an operating day for the facility 200 when the power consumption of today of the facility 200 is greater than or equal to the first threshold value. Also, when having estimated that today is an operating day for the facility 200, the processing circuitry 110 corrects today to be a non-operating day for the facility 200 if the duration in which the power consumption of the facility 200 on today is less than or equal to the second threshold value is longer than or equal to the specified time. According to this configuration, it is possible to correct the deviation by detecting the deviation between the estimation result and the actual operating status based on the power consumption of the day.

(4) The processing circuitry 110 determines whether to issue a cooperation request for today’s demand response based on today’s power consumption in the power grid to the facilities 200 for which it has been estimated that today is an operating day. When determining that a cooperation request for today’s demand response should be issued, the processing circuitry 110 performs the target-day request process on the facilities 200 for which today has been estimated to be an operating day. The target-day request process issues a cooperation request for today’s demand response to the facilities 200 for which it has been estimated that today is an operating day. As a result, the cooperation request for the demand response on the day can be transmitted to the facility 200 for which target the day is an operating day. Therefore, it is possible to adjust the balance between the demand and the supply of the electric power while suppressing the cooperation request to the demand response in the unnecessary scene.

### Modifications

The above embodiment may be modified as follows. The above-described embodiment and the following modifications can be combined as long as the combined modifications remain technically consistent with each other.

The correction process executed by the processing circuitry 110 is not limited to the above. For example, the manager of the facility 200 may manually correct the estimation result of the estimation process.

The procedures of the first correction process and the second correction process are not limited to the above. For example, in the first correction process, in a case in which a duration in which the power consumption of the facility 200 on today is greater than or equal to the first threshold value is longer than or equal to the specified time, today may be corrected to be an operating day for the facility 200. In addition, in the second correction process, for example, in a case in which power consumption at a prescribed time is less than or equal to a second threshold value, today may be corrected to a non-operating day for the facility 200.

### The information processing device may not execute the target-day request process.

The information processing device is not limited to a device that includes a CPU and a memory module and executes software processing. For example, the information processing device may include a hardware circuit, such as an application-specific integrated circuit (ASIC), that execute at least part of the processes executed by the software in the above-described embodiment. That is, the information processing device may be modified as long as it includes processing circuitry that has any one of the following configurations (a) to (c). (a) Processing circuitry including one or more processors that execute all of the above-described processes according to programs and one or more program storage devices such as ROMs that store the programs. (b) Processing circuitry including one or more processors and one or more program storage devices that execute part of the above-described processes according to the programs and one or more dedicated hardware circuits that execute the remaining processes. (c) Processing circuitry including one or more dedicated hardware circuits that execute all of the above-described processes. The program storage devices, which are computer-readable media, include any type of medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An information processing device, comprising processing circuitry, wherein
the processing circuitry is configured to execute an estimation process and a preliminary request process in order to adjust a balance between supply and demand of electric power in a power grid included in an energy management system, the power grid including multiple facilities,
the estimation process includes:
estimating that a following day is an operating day for a facility for which today is an operating day and a duration of consecutive operating days is shorter than a specified duration; and
estimating that the following day is a non-operating day for a facility for which today is a non-operating day and a facility for which a duration of consecutive operating days is longer than or equal to the specified duration; and
the preliminary request process includes:
excluding one or more facilities for which the following day has been estimated to be a non-operating day from candidate destinations for transmission of a cooperation request for a following-day demand response that is a demand response for the following day;
selecting one or more facilities to which the cooperation request for the following-day demand response is to be transmitted, from among one or more facilities for which the following day has been estimated to be an operating day, based on a forecast result of power demand in the power grid for the following day; and
transmitting the cooperation request for the following-day demand response to the selected one or more facilities by the end of today.

2. The information processing device according to claim 1, wherein the processing circuitry is configured to execute a correction process of correcting an estimation result of the estimation process executed on a previous day based on power consumption of today.

3. The information processing device according to claim 2, wherein the processing circuitry is configured to perform:
when having estimated that today is a non-operating day for a facility, correcting today to be an operating day for that facility if the power consumption of today of the facility is greater than or equal to a first threshold value; and
when having estimated that today is an operating day for a facility, correcting today to be a non-operating day for that facility if a duration in which power consumption of the facility on today is less than or equal to a second threshold value is longer than or equal to a specified time.

4. The information processing device according to claim 1, wherein the processing circuitry is configured to perform:
determining, based on power consumption in the power grid of today, whether to transmit a cooperation request for a today’s demand response, which is a demand response of today, to a facility for which it has been estimated that today is an operating day; and
in a case in which it is determined that the cooperation request for the today’s demand response should be issued, executing a target-day request process that includes issuing the cooperation request for the today’s demand response to the facility for which it has been estimated that today is an operating day.
